(19) United States
(12) Patent Application Publication
(10) Pub. No.: US 2010/0069522 A1
(43) Pub. Date: Mar. 18, 2010

(54) LENSES COMPRISING AMPHIPHILIC MULTIBLOCK COPOLYMERS

(76) Inventors: Jeffrey G. Linhardt, Fairport, NY (US); Devon A. Shipp, Potsdam, NY (US); Jay F. Kunzler, Canandaigula, NY (US); Drazen Pavlovic, Zagreb (HR)

Correspondence Address: Bausch & Lomb Incorporated, One Bausch & Lomb Place, Rochester, NY, 14604-2701, US

(21) Appl. No.: 12/404,672

(22) Filed: Mar. 16, 2009

Related U.S. Application Data
(60) Provisional application No. 61/037,063, filed on Mar. 17, 2008.
(60) Provisional application No. 61/078,064, filed on Jul. 3, 2008.

(51) Int. Cl. B29D 11/00; C08F 271/02; C08J 3/28

(52) U.S. Cl. 522/112; 525/203; 525/218; 264/1.1; 264/2.6

(57) ABSTRACT

This invention describes the use of amphiphilic multiblock copolymers comprising a hydrophobic segment and a hydrophilic the amphiphilic multiblock copolymer has at least one thio carbonyl thio group capable of participating in a free radical reaction as comonomers in forming ophthalmic devices such as contact lenses, intraocular lenses, corneal implants, etc.

### CROSS-REFERENCE TO RELATED APPLICATIONS

This application claims priority to U.S. Provisional Patent Application No. 61/037,063, filed on Mar. 17, 2008, and U.S. Provisional Patent Application No. 61/078,064, filed on Jul. 3, 2008, the contents of each of which are incorporated by reference herein.

### BACKGROUND

Polydimethylsiloxane (PDMS)-containing block copolymers are of growing interest due to their unique properties giving scope to many diverse applications. The exceptional properties of PDMS-containing macromolecules include high stability toward heat and UV irradiation, low melting and glass transition temperatures, very low surface tension and good gas permeability, and importantly, they are nontoxic and bio-compatible. Due to these useful and well-established properties polydimethylsiloxanes have been widely used in a variety of biomedical applications, but depending on the application, their hydrophobicity is often a problem. This can be overcome with the incorporation of hydrophilic polymers, such as poly(N,N-dimethylacrylamide) (PDMA) which if combined into a block copolymer to avoid macro-phase separation should allow the PDMS phase to swell in water and be wettable. The combination of these two polymers also opens the way to various new applications. For instance, there is a growing need for the development of new biomaterials that exhibit a wide range of properties yet retain basic requirement of biocompatibility and often several other attributes such as blood compatibility, physiological inertness, oxygen permeability, wettability, low modulus and thermal and oxidative stability. These are often the key parameters in materials used in applications such as prostheses, implants and ophthalmic applications.

Synthetic methodologies leading to the incorporation of PDMS segments into block copolymers have included pairing of PDMS with a wide range of polymers including styrene, polyamides, imines, and several methacrylates. To synthesize these polymers, various methods have been used, including those based on living radical polymerization techniques. Among them, reversible addition-fragmentation chain transfer (RAFT) polymerization and atom transfer radical polymerization (ATRP) have been the most widely studied especially to synthesize block copolymers containing PDMS. For example, Matyjaszewski et al., J. Chem. Rev. 2001, 101, 2921-2990, have synthesized PDMS-polystyrene based block copolymers using ATRP. Haddleton et al., J. Polym. Sci. Part A: Polym. Chem. 2001, 39, 1833-1842, have also used ATRP to synthesize PDMS-poly(methyl methacrylate) triblock copolymers as well as PDMS-poly(2-dimethylaminoethyl methacrylates), and have published a preliminary report on their bulk and surface characteristics. Thirdly, by using RAFT process Pai et al., Polymer 2004, 45, 4383-4389, have prepared PDMS-based triblock copolymers where the outer blocks were statistical copolymers consisting of two monomers, N,N-dimethylacrylamide (DMA) and 2-(N-butyl perfluorooctanefluorosulfonamido) ethyl acrylate. Recently, Kennedy et al., J. Polym. Sci. Part A: Polym. Chem. 2007, 45, 4284-4290, have synthesized PDMA-b-PDMS-b-PDMA triblock copolymer by RAFT polymerization that was used as a precursor for the synthesis of new methacrylate (MA)-telechelic amphiphilic pentablock, MA-b-PHEA-b-PDMA-b-PDMS-b-PDMA-b-PHEA-MA. In each of these studies, a mono- or di-functionalized PDMS macroinitiator was used to grow subsequent triblock copolymers.

While di- and tri-block copolymers have many interesting properties in their own right, multiblock copolymers, with a repeating units that take the form of (AB)ₙ, also have attractive properties and potentially can access different morphologies to their simpler analogues; for example, they are predicted to have secondary periodic microdomain structures in their condensed phase. However, compared to di- and tri-block copolymers, there has been less focus on multiblocks (particularly those containing vinyl monomer units) because they can be challenging to synthesize. Amphiphilic multiblock copolymers containing PDMS and PDMA have been synthesized.

Medical devices such as ophthalmic lenses can generally be subdivided into two major classes, namely hydrogels and non-hydrogels. Non-hydrogels do not absorb appreciable amounts of water, whereas hydrogels can absorb and retain water in an equilibrium state.

Hydrogels are widely used as soft contact lens materials. It is known that increasing the hydrophilicity of the contact lens surface improves the wettability of the contact lenses. This in turn is associated with improved wear comfort of contact lenses. Additionally, the surface of the lens can affect the overall susceptibility of the lens to deposition of proteins and lipids from the tear fluid during lens wear. Accumulated deposits can cause eye discomfort or even inflammation. In the case of extended wear lenses (i.e. lenses used without daily removal of the lens before sleep), the surface is especially important, since extended wear lenses must be designed for high standards of comfort and biocompatibility over an extended period of time. Thus new formulations that have the potential to yield improved surface qualities are still desirable in this field of art.

### SUMMARY

Disclosed in embodiments herein are ophthalmic devices comprising amphiphilic multiblock and triblock copolymers. Although the detailed description and examples herein are directed toward PDMS-PDMA block copolymers these are preferred embodiments and not intended to be limiting of the invention.

### BRIEF DESCRIPTION OF THE DRAWINGS

FIG. 1 is a schematic representation of synthesis of ester-based multifunctional macro RAFT agents starting from PDMS diols;

FIG. 2 is GPC traces of hydroxypropyl terminated PDMS 3b (A), crude product of condensation of hydroxypropyl terminated PDMS with trithiocarbonate 1 (B), and purified PDMS macro RAFT agent 4b (C);

FIG. 3 is a schematic representation of synthesis of amide-based multifunctional macro RAFT agents 6a-c;

FIG. 4 is a schematic representation of synthesis of PDMS-PDMA multiblock copolymers 7a-c and 8a-c;

FIG. 5 is ¹H NMR spectrum of PDMS-PDMA multiblock copolymer 8b;

FIG. 6 is a schematic representation of synthesis of ester-based difunctional macro RAFT agent 11b;

FIG. 7 is chromatography of difunctional ester-based macro RAFT agent 11b;

FIG. 8 is ¹H NMR spectrum of difunctional RAFT agent 11b;

FIG. 9 is ¹³C NMR spectrum of difunctional RAFT agent 11b;

FIG. 10 is a schematic representation of synthesis of amide-based difunctional macro RAFT agent 13b;

FIG. 11 is GPC traces obtained by column chromatography of difunctional amide-based macro RAFT agent 13b shown in Scheme 5;

FIG. 12 is a schematic representation of synthesis of PDMS-PDMA triblock copolymers;

FIG. 13 is extension of ester-based difunctional macro RAFT agent 11b;

FIG. 14 is ¹H NMR spectrum of PDMS-PDMA triblock copolymer (DMA/macro RAFT agent ratio=80);

FIG. 15 is a ¹H NMR spectrum of PDMS-PDMA triblock copolymer (DMA/macro RAFT agent ratio=400);

FIG. 16 is a ¹H NMR spectrum of PDMS-PDMA triblock copolymer (DMA/macro RAFT agent ratio=80);

FIG. 17 is a ¹³C NMR spectrum of PDMS-PDMA triblock copolymer.

FIG. 18 is a Example plot of coefficient of friction (COF) vs. time indicating the origins for the values obtained for the static (peak) and kinetic (average) COF values;

FIG. 19 is a chart showing Normalized static COF values;

FIG. 20 is a chart showing Normalized kinetic COF values;

FIG. 21 is the 1H NMR spectra of DP-02-047.

### DETAILED DESCRIPTION

Disclosed herein are ophthalmic devices comprising amphiphilic multiblock copolymers comprising a hydrophobic segment and a hydrophilic segment, wherein the amphiphilic multiblock copolymer has at least one thio carbonyl thio group capable of participating in a free radical reaction.

Examples of biomaterials useful in the present invention are taught in U.S. Pat. Nos. 5,908,906 to Kunzler et al.; 5,714,557 to Kunzler et al.; 5,710,302 to Kunzler et al.; 5,708,094 to Lai et al.; 5,616,757 to Bambury et al.; 5,610,252 to Bambury et al.; 5,512,205 to Lai; 5,449,729 to Lai; 5,387,662 to Kunzler et al. and 5,310,779 to Lai; which patents are incorporated by reference as if set forth at length herein.

Rigid gas-permeable (RGP) materials typically comprise a hydrophobic cross-linked polymer system containing less than 5 wt. % water. RGP materials useful in accordance with the present invention include those materials taught in U.S. Pat. Nos. 4,826,936 to Ellis; 4,463,149 to Ellis; 4,604,479 to Ellis; 4,686,267 to Ellis et al.; 4,826,936 to Ellis; 4,996,275 to Ellis et al.; 5,032,658 to Baron et al.; 5,070,215 to Bambury et al.; 5,177,165 to Valint et al.; 5,177,168 to Baron et al.; 5,219,965 to Valint et al.; 5,336,797 to McGee and Valint; 5,358,995 to Lai et al.; 5,364,918 to Valint et al.; 5,610,252 to Bambury et al.; 5,708,094 to Lai et al; and 5,981,669 to Valint et al. U.S. Pat. No. 5,346,976 to Ellis et al. teaches a preferred method of making an RGP material.

The invention is applicable to a wide variety of polymeric materials, either rigid or soft. Especially preferred polymeric materials are ophthalmic devices including contact lenses, phakic and aphakic intraocular lenses and corneal implants although all polymeric materials including biomaterials are contemplated as being within the scope of this invention. Hydrogels comprise hydrated, crosslinked polymeric systems containing water in an equilibrium state. Such hydrogels could be silicone hydrogels, which generally have water content greater than about five weight percent and more commonly between about ten to about eighty weight percent. Such materials are usually prepared by polymerizing a mixture containing at least one siloxane-containing monomer and at least one hydrophilic monomer. Applicable siloxane-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995. Moreover, the use of siloxane-containing monomers having certain fluorinated side groups, i.e. —(CF₂)—H, have been found to improve compatibility between the hydrophilic and siloxane-containing monomeric units, as described in U.S. Pat. Nos. 5,387,662 and 5,321,108.

The hydrophobic segment of the amphiphilic multiblock copolymer of the invention herein is preferably obtained from commercially available polymeric hydrophobic materials and is selected from the group consisting of polysiloxanes, perfluorinated polyethers and hydroxyl terminated polydienes. Polysiloxanes are mixed inorganic-organic polymers with the chemical formula [R₂SiO]ₙ, where R=organic groups such as methyl, ethyl, and phenyl. These materials consist of an inorganic silicon-oxygen backbone with organic side groups attached to the silicon atoms, which are four-coordinate. In some cases organic side groups can be used to link two or more of these —Si—O— backbones together. By varying the —Si—O— chain lengths, side groups, and crosslinking, silicones can be synthesized with a wide variety of properties and compositions. Polysiloxanes are commercially available from suppliers such as Gelest, Inc., Morrisville, Pa. Perfluoropolyethers (PFPE) can be prepared by fluorinating addition polymers made by polymerizing epoxides and are commercially available under the tradenames Fomblin and Krytox, manufactured by Ausimont and DuPont respectively. Hydroxyl terminated polydienes would include hydroxyl-terminated polybutadiene (HTPB). HTPB is a polymer of butadiene terminated at each end with a hydroxyl functional group. It belongs to a class of polymers known as polyols. HTPB is a clear, viscous liquid whose general properties cannot be precisely stated because HTPB is manufactured in various grades to meet specific requirements. HTPB is thus a generic name for a class of compounds.

In addition to the hydrophobic segment, the amphiphilic multiblock copolymers of the invention herein will also contain hydrophilic domain(s) showing good surface properties when the block copolymer is covalently bound to substrates containing complimentary functionality. The hydrophilic domain(s) will comprise at least one hydrophilic monomer, such as, HEMA, glycerol methacrylate, methacrylic acid (“MAA”), acrylic acid (“AA”), methacrylamide, acrylamide, N,N′-dimethylmethacrylamide, or N,N′-dimethylacrylamide; copolymers thereof; hydrophilic prepolymers, such as ethylenically unsaturated poly(alkylene oxide)s, cyclic lactams such as N-vinyl-2-pyrrolidone (“NVP”), or derivatives thereof. Still further examples are the hydrophilic vinyl carbonate or vinyl carbamate monomers. Hydrophilic monomers can be nonionic monomers, such as 2-hydroxyethyl methacrylate (“HEMA”), 2-hydroxyethyl acrylate (“HEA”), 2-(2-ethoxyethoxy)ethyl(meth)acrylate, glyceryl(meth)acrylate, poly(ethylene glycol (meth)acrylate), tetrahydrofurfuryl(meth)acrylate, (meth)acrylamide, N,N′-dimethylmethacrylamide, N,N′-dimethylacrylamide (“DMA”), N-vinyl-2-pyrrolidone (or other N-vinyl lactams), N-vinyl acetamide, and combinations thereof. Still further examples of hydrophilic monomers are the vinyl carbonate and vinyl carbamate monomers disclosed in U.S. Pat. No. 5,070,215, and the hydrophilic oxazolone monomers disclosed in U.S. Pat. No. 4,910,277. The contents of these patents are incorporated herein by reference. The hydrophilic monomer also can be an anionic monomer, such as 2-methacryloyloxyethylsulfonate salts. Substituted anionic hydrophilic monomers, such as from acrylic and methacrylic acid, can also be utilized wherein the substituted group can be removed by a facile chemical process. Non-limiting examples of such substituted anionic hydrophilic monomers include trimethylsilyl esters of (meth)acrylic acid, which are hydrolyzed to regenerate an anionic carboxyl group. The hydrophilic monomer also can be a cationic monomer selected from the group consisting of 3-methacrylamidopropyl-N,N,N-trimethyammonium salts, 2-methacryloyloxyethyl-N,N,N-trimethylammonium salts, and amine-containing monomers, such as 3-methacrylamidopropyl-N,N-dimethyl amine. Other suitable hydrophilic monomers will be apparent to one skilled in the art.

The thio carbonyl thio group capable of participating in a free radical reaction of the amphiphilic multiblock copolymer of the invention herein is selected from the group consisting of dithioesters, trithiocarbonates, dithiocarbamates and xanthates which act as transfer agents used in controlled free-radical polymerization.

In this work we have used S,S′-bis(α,α′-dimethyl-α″-acetic acid)trithiocarbonate (1) as a convenient source of trithiocarbonyl group. Chain transfer agent was synthesized according to the one-pot synthesis reported by Lai et al., Macromolecules 2002, 35, 6754-6756. Symmetrical structure of 1 is ideally suited for chain extension in both directions and was chosen for its high chain transfer efficiency in radical polymerization of acrylamides. It is also know from the literature that well-defined multiblock amphiphilic copolymers can be successfully prepared using the thiocarbonate-embedded poly(ethylene oxide) as the macro-RAFT agent. We report here a simple and efficient procedure for the synthesis of a new multifunctional and difunctional CTA in which the thiocarbonylthio groups are linked by a hydroxyl- or aminopropyl-terminated PDMS residue. Telechelic polymers thus synthesized are macromolecular chain transfer agents in the reversible addition fragmentation chain transfer polymerization of N,N-dimethylaminoacrylamide, enabling the synthesis of (AB)n-type multiblock and ABA-type triblock copolymers of varying compositions possessing monomodal molecular weight distributions.

Multifunctional PDMS Macro-RAFT Agents from Diol-PDMS Precursors

Multifunctional thiocarbonylthio macro RAFT agent is synthesized by coupling the commercially available precursor hydroxypropyl-terminated PDMS of various molar masses (Mn=1000, 2100, 5000 g/mol) to trithiocarbonate according to a procedure reported by Hillmyer et al., Macromolecules 2005, 38, 7890-7894, with slight modification. Reaction of RAFT agent 1 with oxalyl chloride at reflux for 3 h and subsequent removal of the excess of chlorinating agent in vacuo afforded acetyl chloride in quantitative yield. The polymeric trithiocarbonate embedded PDMS macro RAFT agent is synthesized through a polyesterification by coupling α,ω-dihydroxypropyl PDMS with trithiocarbonate in methylene chloride at 0° C. using triethylamine as a base. Flash chromatography allowed us to separate the multifunctional macro RAFT agent, which eluted first, from the unreacted PDMS diol.

The number-average molecular weight (Mn) and the polydispersity (Mw/Mn) of hydroxypropyl terminated PDMS and its corresponding macro RAFT agent were derived from GPC data, in which PDMS precursor has a number-average molecular weight (Mₙ) 2100 g/mol and polydispersity 1.2. After polycondensation, a broader and multimodal trace for the crude product appeared. This indicates that the desired main product with higher molecular weight was mixed with unreacted PDMS diol and perhaps also degraded PDMS byproduct formed by the partial base hydrolysis of ester groups in macro RAFT agent. The molecular weight and polydispersity of purified PDMS macro RAFT agent were determined to be 7,500 g/mol and 1.18, respectively.

By comparing the molecular weight of PDMS macro RAFT agent with that of PDMS precursor derived from GPC, it is calculated that there is about 3-4 prepolymer PDMS blocks connected together by trithiocarbonate groups. The ¹H NMR of macro RAFT agent (PDMS-RAFT)ₙ also confirmed the incorporation of trithiocarbonate moiety into the PDMS prepolymer chain.

The same procedure that was applied for PDMS diols was repeated with PDMS diamines as starting materials to get diamide type RAFT agents. Molecular weights of the commercially available diamine starting materials were 1000, 2000, and 5000, respectively, with polydispersity index 2.3. Structure of the products was confirmed by proton and carbon NMR spectroscopy, as well as GPC analysis.

### Synthesis of PDMS-PDMA Multi-Block Copolymers.

All polymerizations of DMA in the presence of the PDMS-based macro-RAFT agents were carried out in THF at 60° C. First we set the monomer to RAFT agent molar ratio at 80:1 and the initiator to RAFT molar agent ratio approximately between 1:10 and 1:5 to minimize the fraction of chains derived from AIBN. Next, we polymerized DMA under the same conditions (THF, 60° C., AIBN) but varied the monomer/RAFT agent molar ratio. All polymerizations were left to proceed to high conversions (70-90%).

The polymers were isolated and purified by re-precipitation of THF solutions into hexane or diethyl ether. Although GPC analysis is convoluted due to the varying solubilities of the two monomers in the block copolymers, we were able to obtain basic GPC data. The polymers derived from ester-based macro RAFT agents have lower polydispersities (usually from 1.2-1.4) as compared to polymers obtained from amido-based macro RAFTs where PD's were around 2.3. The elution profiles were monomodal and symmetrical especially for the polymers obtained from ester RAFTs, except in the case of the polymers of highest molecular mass for which the GPC trace usually presents a small shoulder on the high-molar-mass side.

The difunctional thiocarbonylthio RAFT agent was synthesized by a two-step procedure involving the preparation of S-1-dodecyl-S′-(α,α′-dimethyl-α,α″-acetic acid)-trithiocarbonate, according to the one-pot procedure reported by Lai et al., Macromolecules 2002, 35, 6754-6756, followed by diesterification of PDMS diol activated via conversion to the corresponding acyl chloride prior to coupling. A 1.25-fold molar excess of acyl chloride was added relative to the hydroxyl groups of PDMS precursor to ensure complete conversion of the PDMS end groups. The excess acyl chloride was quenched with methanol added in excess at the end of reaction. As a result some methyl ester of trithiocarbonate diacid was formed as a byproduct.

Amide-based macro RAFT agent was synthesized. The amidation of commercially available terminal diamine (Mₙ=2500 g/mol) with the acyl chloride proceeded smoothly to afford product in 80% isolated yield after column chromatography of the crude reaction mixture on silica gel using hexane/CH₂Cl₂ as eluent (gradient elution 50-100 v/v % hexane/CH₂Cl₂). Structure of the macro RAFT agent was confirmed by proton and carbon NMR spectroscopy, as well as GPC analysis.

The polymerizable composition may, further as necessary and within limits not to impair the purpose and effect of the present invention, contain various additives such as antioxidant, coloring agent, ultraviolet absorber and lubricant.

In the present invention, the polymerizable composition may be prepared by using, according to the end-use and the like of the resulting shaped polymer articles, one or at least two of the above comonomers and oligomers and functionalized surfactants; and, when occasions demand, one or more crosslinking agents.

Where the shaped polymer articles are for example medical products, in particular a contact lens, the polymerizable composition is suitably prepared from one or more of the silicon compounds, e.g. siloxanyl(meth)acrylate, siloxanyl(meth)acrylamide and silicone oligomers, to obtain contact lenses with high oxygen permeability.

The monomer mix of the present invention may include additional constituents such as crosslinking agents, internal wetting agents, hydrophilic monomeric units, toughening agents, and other constituents as is well known in the art.

Although not required, compositions within the scope of the present invention may include toughening agents, preferably in quantities of less than about 80 weight percent e.g. from about 5 to about 80 weight percent, and more typically from about 20 to about 60 weight percent. Examples of suitable toughening agents are described in U.S. Pat. No. 4,327,203. These agents include cycloalkyl acrylates or methacrylates, such as: methyl acrylate and methacrylate, t butylcyclohexyl methacrylate, isopropylcyclopentyl acrylate, t pentylcyclo-heptyl methacrylate, t butylcyclohexyl acrylate, isohexylcyclopentyl acrylate and methylisopentyl cyclooctyl acrylate. Additional examples of suitable toughening agents are described in U.S. Pat. No. 4,355,147. This reference describes polycyclic acrylates or methacrylates such as: isobornyl acrylate and methacrylate, dicyclopentadienyl acrylate and methacrylate, adamantyl acrylate and methacrylate, and isopinocamphyl acrylate and methacrylate. Further examples of toughening agents are provided in U.S. Pat. No. 5,270,418. This reference describes branched alkyl hydroxylcycloalkyl acrylates, methacrylates, acrylamides and methacrylamides. Representative examples include: 4-t-butyl-2-hydroxycyclohexyl methacrylate (TBE); 4-t-butyl-2-hydroxycyclopentyl methacrylate; methacryloxyamino-4-t-butyl-2-hydroxycyclohexane; 6-isopentyl-3-hydroxycyclohexyl methacrylate; and methacryloxyamino-2-isohexyl-5-hydroxycyclopentane.

Internal wetting agents may also be used for increasing the wettability of such hydrogel compositions. Examples of suitable internal wetting agents include N-alkyenoyl trialkylsilyl aminates as described in U.S. Pat. No. 4,652,622. These agents can be represented by the general formula:

CH2=C(E)C(O)N(H)CH(G)(CH2)qC(O)OSi(V)3

wherein:
E is hydrogen or methyl,
G is (CH2)rC(O)OSi(V)3 or hydrogen,
V is methyl, ethyl or propyl,
q is an integer form 1 to 15,
r is an integer form 1 to 10,
q+r is an integer form 1 to 15, hereinafter referred to as NATA.

Acryloxy- and methacryloxy-, mono- and dicarboxylic amino acids, hereinafter NAA, impart desirable surface wetting characteristics to polysiloxane polymers, but precipitate out of monomer mixtures that do not contain siloxane monomers before polymerization is completed. NAA can be modified to form trialkylsilyl esters which are more readily incorporated into polysiloxane polymers. The preferred NAAs are trimethylsilyl-N-methacryloxyglutamate, triethylsilyl-N-methacryloxyglutamate, trimethyl-N-methacryloxy-6-aminohexanoate, trimethylsilyl-N-methacryloxy-aminododecanoate, and bis-trimethyl-silyl-N-methacryloxyaspartate.

Preferred wetting agents also include acrylic and methacylic acids, and derivatives thereof. Typically, such wetting agents comprise less than 5 weight percent of the composition.

Other preferred internal wetting agents include oxazolones as described in U.S. Pat. No. 4,810,764 to Friends et al. issued Mar. 7, 1989, the contents of which are incorporated by reference herein. These preferred internal wetting agents specifically include 2-isopropenyl-4,4-dimethyl-2-oxazolin-5-one (IPDMO), 2-vinyl-4,4-dimethyl-2-oxazolin-5-one (VDMO), cyclohexane spino-4′-(2′isopropenyl-2′-oxazol-5′-one) (IPCO), cyclohexane-spiro-4′-(2′-vinyl-2′-oxazol-5′-one) (VCO), and 2-(-1-propenyl)-4,4-dimethyl-oxazol-5-one (PDMO). The preparation of such oxazolones is known in the art and is described in U.S. Pat. No. 4,810,764.

These preferred internal wetting agents have two important features which make them particularly desirable wetting agents: (1) they are relatively non-polar and are compatible with the hydrophobic monomers (the polysiloxanes and the toughening agents), and (2) they are converted to highly polar amino acids on mild hydrolysis, which impart substantial wetting characteristics. When polymerized in the presence of the other components, a copolymer is formed. These internal wetting agents polymerize through the carbon-carbon double bond with the endcaps of the polysiloxane monomers, and with the toughening agents to form copolymeric materials particularly useful in biomedical devices, especially contact lenses.

As indicated, the subject hydrogel compositions includes hydrophilic monomeric units. Examples of appropriate hydrophilic monomeric units include those described in U.S. Pat. Nos. 4,259,467; 4,260,725; 4,440,918; 4,910,277; 4,954,587; 4,990,582; 5,010,141; 5,079,319; 5,310,779; 5,321,108; 5,358,995; 5,387,662; all of which are incorporated herein by reference. Examples of preferred hydrophilic monomers include both acrylic- and vinyl-containing monomers such as hydrophilic acrylic-, methacrylic-, itaconic-, styryl-, acrylamido-, methacrylamido- and vinyl-containing monomers

Preferred hydrophilic monomers may be either acrylic- or vinyl-containing. Such hydrophilic monomers may themselves be used as crosslinking agents. The term “vinyl-type” or “vinyl-containing” monomers refers to monomers containing the vinyl grouping (CH2=CQH), and are generally highly reactive. Such hydrophilic vinyl-containing monomers are known to polymerize relatively easily. “Acrylic-type” or “acrylic-containing” monomers are those monomers containing the acrylic group represented by the formula:

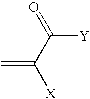

wherein X is preferably hydrogen or methyl and Y is preferably —O—, —OQ-, —NH—, —NQ- and —NH(Q)-, wherein Q is typically an alkyl or substituted alkyl group. Such monomers are known to polymerize readily.

Preferred hydrophilic vinyl-containing monomers which may be incorporated into the hydrogels of the present invention include monomers such as N-vinyllactams (e.g. N-vinylpyrrolidone (NVP)), N-vinyl-N-methylacetamide, N-vinyl-N-ethylacetamide, N-vinyl-N-ethylformamide, N-vinylformamide, with NVP being the most preferred.

Preferred hydrophilic acrylic-containing monomers which may be incorporated into the hydrogel of the present invention include hydrophilic monomers such as N,N-dimethylacrylamide (DMA), 2-hydroxyethyl methacrylate, glycerol methacrylate, 2-hydroxyethyl methacrylamide, methacrylic acid and acrylic acid, with DMA being the most preferred.

Suitable ethylenically unsaturated hydrophilic monomers include ethylenically unsaturated polyoxyalkylenes, polyacrylamides, polyvinylpyrrolidones, polyvinyl alcohols, poly(hydroxyethyl methacrylate) or poly (HEMA), and N-alkyl-N-vinylacetamides. Ethylenic unsaturation may be provided by (meth)acrylate, (meth)acrylamide, styrenyl, alkenyl, vinyl carbonate and vinyl carbamate groups. Preferred hydrophilic macromonomers include methoxypolyoxyethylene methacrylates of molecular weights from 200 to 10,000, more preferred are methoxypolyoxyethylene methacrylates of molecular weight range of 200 to 5,000 and most preferred are methoxypolyoxyethylene methacrylates of molecular weight range of 400 to 5,000. Additional preferred hydrophilic macromonomers include poly(N-vinylpyrrolidone) methacrylates of molecular weights of 500 to 10,000. More preferred are poly(N-vinylpyrrolidone methacrylates) of molecular weights of 500 to 5,000 and most preferred are poly(N-vinylpyrrolidone) methacrylates of molecular weights of 1000 to 5,000. Other preferred hydrophilic macromonomers include poly(N,N-dimethyl acrylamide methacrylates) of molecular weights of 500 to 10,000. More preferred are poly(N,N-dimethylacrylamide methacrylates) of molecular weights of 500 to 5,000 and most preferred are poly(N,N-dimethylacrylamide methacrylates) of molecular weights of 1000 to 5,000.

Suitable ethylenically unsaturated hydrophobic monomers include alkyl (meth)acrylates, N-alkyl(meth)acrylamides, alkyl vinylcarbonates, alkyl vinylcarbamates, fluoroalkyl(meth)acrylates, N-fluoroalkyl(meth)acrylamides, N-fluoroalkyl vinylcarbonates, N-fluoroalkyl vinylcarbamates, silicone-containing (meth)acrylates, (meth)acrylamides, vinyl carbonates, vinyl carbamates, styrenic monomers [selected from the group consisting of styrene, α-methyl styrene, ρ-methyl styrene, ρ-t-butylmonochlorostyrene, and ρ-t-butyldichlorostyrene] and poly[oxypropylene (meth)acrylates]. Preferred hydrophobic monomers include methyl methacrylate, dodecyl methacrylate, octafluoropentyl methacrylate, hexafluoroisopropyl methacrylate, perfluorooctyl methacrylate, methacryoyloxypropyltris(trimethylsiloxy)silane (TRIS).

When both an acrylic-containing monomer and a vinyl-containing monomer are incorporated into the invention, a further crosslinking agent having both a vinyl and an acrylic polymerizable group may be used, such as the crosslinkers which are the subject of U.S. Pat. No. 5,310,779, issued May 10, 1994, the entire content of which is incorporated by reference herein. Such crosslinkers help to render the resulting copolymer totally UV-curable. However, the copolymer could also be cured solely by heating, or with a combined UV and heat regimen. Photo and/or thermal initiators required to cure the copolymer will be included in the monomer mix, as is well-known to those skilled in the art. Other crosslinking agents which may be incorporated into the silicone-containing hydrogel including those previously described. Other techniques for increasing the wettability of compositions may also be used within the scope of the present invention, e.g. plasma surface treatment techniques which are well known in the art.

Particularly preferred hydrogel compositions comprise from about 0.1 to about 50 weight percent of amphiphilic multiblock and triblock copolymers, from about 0.1 to about 30 weight percent of amphiphilic multiblock and triblock copolymers, and from about 0.1 to about 4.9% weight percent of amphiphilic multiblock and triblock copolymers.

The monomer mixes employed in this invention, can be readily cured to desired shapes by conventional methods such as UV polymerization, or thermal polymerization, or combinations thereof, as commonly used in polymerizing ethylenically unsaturated compounds. Representative free radical thermal polymerization initiators are organic peroxides, such as acetyl peroxide, lauroyl peroxide, decanoyl peroxide, stearoyl peroxide, benzoyl peroxide t butyl peroxypivalate, peroxydicarbonate, and the like, employed in a concentration of about 0.01 to 1 percent by weight of the total monomer mixture. Representative UV initiators are those known in the field such as, benzoin methyl ether, benzoin ethyl ether, DAROCUR 1173, 1164, 2273, 1116, 2959, 3331 (EM Industries) and IGRACUR 651 and 184 (Ciba-Geigy).

Polymerization of the amphiphilic multiblock and triblock copolymers with other comonomers is generally performed (with crosslinking agents) in the presence of a diluent. The polymerization product will then be in the form of a gel. If the diluent is nonaqueous, the diluent must be removed from the gel and replaced with water through the use of extraction and hydration protocols well known to those of ordinary skill in the art. It is also possible to perform the polymerization in the absence of diluent to produce a xerogel. These xerogels may then be hydrated to form the hydrogels as is well known in the art.

In addition to the above-mentioned polymerization initiators, the copolymer of the present invention may also include other monomers as will be apparent to one of ordinary skill in the art. For example, the monomer mix may include colorants, or UV-absorbing agents such as those known in the contact lens art.

The present invention provides materials which can be usefully employed for the fabrication of prostheses such as heart valves and intraocular lenses, films, surgical devices, heart valves, vessel substitutes, intrauterine devices, membranes and other films, diaphragms, surgical implants, blood vessels, artificial ureters, artificial breast tissue and membranes intended to come into contact with body fluid outside of the body, e.g., membranes for kidney dialysis and heart/lung machines and the like, catheters, mouth guards, denture liners, ophthalmic devices, and especially contact lenses.

The polymers of this invention can be formed into ophthalmic devices by spincasting processes (such as those disclosed in U.S. Pat. Nos. 3,408,429 and 3,496,254), cast molding, lathe cutting, or any other known method for making the devices. Polymerization may be conducted either in a spinning mold, or a stationary mold corresponding to a desired shape. The ophthalmic device may be further subjected to mechanical finishing, as occasion demands. Polymerization may also be conducted in an appropriate mold or vessel to form buttons, plates or rods, which may then be processed (e.g., cut or polished via lathe or laser) to give an ophthalmic device having a desired shape.

When used in the formation of hydrogel (soft) contact lenses, it is preferred that the subject hydrogels have water contents of from about 20 to about 90 weight percent. Furthermore, it is preferred that such hydrogels have a modulus from about 20 g/mm2 to about 150 g/mm2, and more preferably from about 30 g/mm2 to about 100 g/mm2.

As an illustration of the present invention, several examples are provided below. These examples serve only to further illustrate certain aspects of the invention and should not be construed as limiting the invention.

### EXAMPLES

### Materials

All reagents unless otherwise stated were purchased from Sigma-Aldrich and used without further purification. Azobisisobutyronitrile (AIBN) was recrystallized from methanol prior to use. N,N-Dimethylacrylamide (DMA) was purified by passing over a column of basic alumina to remove inhibitor. Hydroxypropyl terminated polydimethylsiloxanes were purchased from Siltech Corporation. Aminopropyl terminated polydimethylsiloxanes were purchased from Gelest Inc. Tetrahydrofuran (THF) was distilled over CaH₂ prior to use. All other solvents were of reagent grade and used as received.

### Instrumentation

Gel Permeation Chromatography (GPC) was performed on a modular system comprised of the following: a Waters 515 high-pressure liquid chromatographic pump operating at room temperature, a Waters 717 autosampler, and a Viscotek LR40 refractometer. THF was used as a continuous phase at a flow rate of 1.0 mL/min. The columns were calibrated with commercial linear polystyrene and poly(methyl methacrylate) standards. Polymer analyte solutions were prepared with 1.0-2.5 mg/mL, and sample injection volumes of 50 μl were used. ¹H and ¹³C NMR spectra of the polymers were obtained on a Bruker Avance-400 spectrometer using 5 mm o.d. tubes. Sample concentrations were about 25% (w/v) in CDCl₃ containing 1% TMS as an internal reference.

### Example 1

### Synthesis of Multifunctional Ester-Based PDMS Macro RAFT Agent (4b)

Oxalyl chloride (5.0 mL, 57.3 mmol) was added while stirring to S,S′-bis(α,α′-dimethyl-α″-acetic acid)trithiocarbonate 1 (1.0 g, 3.6 mmol) kept under nitrogen at room temperature. At the end of addition, the resulting heterogeneous mixture was warmed up to 60° C. for 3 h, resulting in the formation of a bright yellow solution. The excess oxalyl chloride was evaporated under reduced pressure to yield 1.05 g of S,S′-bis(α,α′-dimethyl-α″-acetyl chloride)trithiocarbonate (1a) as a white solid. Acetyl chloride 1a was dissolved in dry methylene chloride (50 mL) and added dropwise into the solution of hydroxylpropyl terminated PDMS diol 3b (6.77 g, 3.22 mmol) in 200 mL of anhydrous methylene chloride with vigorous stirring at 0° C. After reaction mixture was stirred for 24 h at room temperature the solvent was removed under reduced pressure to give 6.59 g of yellow viscous oil, which was eluted through a short silica gel column using hexane to yield the pure chain transfer agent 4b (4.90 g). ¹H NMR (400 MHz, CDCl₃) δ 3.61 (t, 4H, ³J=6.8 Hz, C(O)OCH₂), 1.74 (s, 12H, C(S)SC(CH₃)₂), 1.64-1.59 (m, 4H, C(O)OCH₂CH₂), 0.56 (dt, 4H, ³J₁=8.4 Hz, ³J₂=4.2 Hz, (CH₃)₂SiOSiCH₂), 0.07 (s, 6H, (CH₃)₂Si). ¹³C NMR (200 MHz, CDCl₃) δ 206.0 (s, SC(S)SC(CH₃)₂), 175.0 (s, C(O)OCH₂CH₂), 65.5 (t, C(O)OCH₂CH₂), 54.0 (s, SC(S)SC(CH₃)₂), 26.6 (t, C(O)OCH₂CH₂), 22.8 (q, SC(S)SC(CH₃)₂), 13.9 (t, (CH₃)₂SiOSiCH₂), 0.98 (q, (CH₃)₂Si). M_{n,GPC}=7,500 g/mol, M_{n,NMR}=6,150 g/mol, PD=1.18.

### Example 2

### Synthesis of Multifunctional Amide-Based PDMS Macro RAFT Agent (6b)

In a three-neck round bottom flask 8.52 g (3.4 mmol) of PDMS diamine precursor 5b was dissolved in methylene chloride (150 mL). Triethylamine (1.43 g, 14.2 mmol) was added, and the solution was cooled in an ice-water bath. In the meantime oxalyl chloride (6 mL) was added to another one-neck round bottom flask containing 1.0 g (3.6 mmoL) of trithiocarbonate diacid 1. After stirring at 60° C. for 2 h, the excess oxalyl chloride was evaporated under reduced pressure, and the remains were dissolved in 50 mL dry methylene chloride and added dropwise to the PDMS diamine solution with vigorous stirring. The reaction mixture was stirred for 18 h at room temperature. The solvent was removed under vacuum, and the obtained yellow oil was filtered through the short plug of silica-gel (eluents: CH₂Cl₂/MeOH 3:1). Evaporation of the combined fractions afforded 7.92 g of macro RAFT agent 6b that was used without further purification in the next step. ¹H NMR (400 MHz, CDCl₃) δ 6.4 (bs, 2H, C(O)NH), 3.33-3.14 (m, 4H, C(O)NHCH₂), 1.70-1.57 (m, 4H, C(O)NHCH₂CH₂), 1.53 (s, 12H, C(S)SC(CH₃)₂), 0.63-0.46 (m, 4H, (CH₃)₂SiOSiCH₂), 0.06 (s, 6H, (CH₃)₂Si). M_{n,GPC}=6,400 g/mol, M_{n,NMR}=6,890 g/mol, PD=2.30.

### Example 3

### Polymerization of N,N-dimethylacrylamide (DMA) in the Presence of Ester-Based Multifunctional Macro RAFT Agent (7b)

A solution of the chain transfer agent 4b (2.04 g, 0.55 mmol), the initiator (AIBN, 35.8 mg, 0.22 mmol), and the monomer (DMA, 4.32 g, 43.6 mmol) in THF (5 mL) was placed in a round-bottom flask with rubber septa. The solution was deoxygenated by bubbling nitrogen for 30 min at room temperature. The reaction flask was placed in an oil bath preheated to 60° C. The polymerization was allowed to proceed for 12 h under constant magnetic stirring. At the end of the polymerization, the thick solution was cooled to room temperature. The polymer was isolated by precipitation in hexane (500 mL), and further purified by two consecutive reprecipitations into hexane. The isolated multiblock copolymer 7b was dried in vacuo to yield 4.38 g of colorless solid with the following spectral characteristics: ¹H NMR (400 MHz, CDCl₃) δ 3.28-2.77 (m, 6H, (CH₃)₂N), 2.73-2.20 (m, 1H, CHC(O)N(CH₃)₂, polymer backbone methine protons), 2.00-0.90 (m, 2H, CH₂CHC(O)N(CH₃)₂, polymer backbone methylene protons), 0.05 (s, 6H, (CH₃)₂Si). M_{n,GPC}=13,900 g/mol, M_{n,NMR}=14,100 g/mol, PD=1.21.

### Example 4

### Polymerization of N,N-dimethylacrylamide (DMA) in the Presence of Amide-Based Multifunctional Macro RAFT Agent (8b)

A solution of the chain transfer agent 6b (1.0 g, 0.16 mmol), the initiator (AIBN, 10.3 mg, 0.063 mmol), and the monomer (DMA, 1.24 g, 12.5 mmol) in THF (3 mL) was placed in a round-bottom flask with rubber septa. The solution was deoxygenated by bubbling nitrogen for 30 min at room temperature. The reaction flask was placed in an oil bath preheated to 60° C. The polymerization was allowed to proceed for 15 h under constant magnetic stirring. At the end of the polymerization, the thick solution was cooled to room temperature. The polymer was isolated by two consecutive reprecipitations into hexane (500 mL) to get 1.53 g of multifunctional copolymer 8b as a bright yellow precipitate. ¹H NMR (400 MHz, CDCl₃) δ 3.21-2.72 (m, 6H, (CH₃)₂N), 2.70-2.23 (m, 1H, CHC(O)N(CH₃)₂, polymer backbone methine protons), 1.90-0.96 (m, 2H, CH₂CHC(O)N(CH₃)₂, polymer backbone methylene protons), 0.56-0.39 (m, 4H, (CH₃)₂SiOSiCH₂), 0.02 (s, 6H, (CH₃)₂Si). ¹³C NMR (200 MHz, CDCl₃) δ 174.8 (s, C(O)NH), 174.5 (s, C(O)NH), 37.1, 36.2, 35.8 (polymer backbone carbons), 1.0 (q, (CH₃)₂Si). M_{n,GPC}=14,000 g/mol, M_{n,NMR}=15,500 g/mol, PD=1.23. According to NMR integration of the PDMS methyl signals the content of PDMS block in the copolymer was determined to be 48%.

### Example 5

### Synthesis of Difunctional Ester-Based PDMS Macro Raft Agent (11b)

Oxalyl chloride (4.9 mL, 56.0 mmol) was added to RAFT-CTA 9 (2.05 g, 5.6 mmol) at room temperature with rapid stirring, and under a nitrogen atmosphere. After 4 h stirring the evolution of gases had ceased and the reaction was homogenous. The excess oxalyl chloride was removed under reduced pressure to yield acyl chloride 10 (2.1 g) which was dissolved in 20 mL of anhydrous methylene chloride. This solution was gradually added dropwise into a solution of PDMS diol 3b (4.48 g, 2.2 mmol) in 80 mL of anhydrous methylene chloride. The reaction mixture was stirred for 14 h at room temperature. At the end of the reaction methanol (2 mL) was added to quench the remaining acyl chloride. The solvents were removed under reduced pressure to give 6.50 g of reddish oil, which was eluted through a silica gel column using methylene chloride/hexane (gradient elution 5-50 v/v % CHCl₂/hexane) as eluent to separate the difunctional macro RAFT agent 11b (4.69 g, 77%) from the monofunctional RAFT agent 12 (0.21 g, 10%) obtained as a byproduct. ¹H NMR (400 MHz, CDCl₃) δ 4.06 (t, 4H, ³J=6.8 Hz, C(O)OCH₂), 3.27 (t, 4H, ³J=7.2 Hz, C(S)SCH₂), 1.70 (s, 12H, C(S)SC(CH₃)₂), 1.68-1.60 (m, 4H, C(O)OCH₂CH₂), 1.45-1.19 (m, 20H, CH₃(CH₂)₁₀), 0.89 (t, 6H, ³J=6.8 Hz, CH₃(CH₂)₁₀), 0.54 (dt, 4H, ³J₁=8.8 Hz, ³J₂=4.0 Hz, (CH₃)₂SiOSiCH₂), 0.09 (s, 6H, (CH₃)₂Si). ¹³C NMR (200 MHz, CDCl₃) δ 173.0 (s, C(O)O), 68.5 (t, C(O)OCH₂), 56.1 (s, C(S)SC(CH₃)₂), 36.9 (t, C(S)SCH₂), 31.9 (t, C(S)SCH₂CH₂), 29.6, (t, CH₃(CH₂)₉, 2C), 29.5 (t, CH₃(CH₂)₉), 29.4 (t, CH₃(CH₂)₉), 29.3 (t, CH₃(CH₂)₉), 29.1 (t, CH₃(CH₂)₉), 29.0 (t, CH₃(CH₂)₉), 27.9 (t, CH₃(CH₂)₉), 25.4 (q, C(S)SC(CH₃)₂), 22.7 (t, CH₃(CH₂)₉), 22.4 (t, C(O)OCH₂CH₂), 14.1 (q, CH₃(CH₂)₉), 14.0 (t, (CH₃)₂SiOSiCH₂), 1.0 (q, (CH₃)₂Si). M_{n,GPC}=4,740 g/mol, M_{n,NMR}=3,800 g/mol, PD=1.19.

### Example 6

### Synthesis of Difunctional Amide-Based PDMS Macro RAFT Agent (13b)

Oxalyl chloride (4.9 mL, 56.2 mmol) was added to solid RAFT agent 9 (2.05 g, 5.62 mmol) at room temperature and under nitrogen atmosphere. After the end of the addition, the mixture was warmed up to 60° C. for 3 h, resulting in the formation of a dark red solution. The excess oxalyl chloride was removed in vacuo to yield 2.10 g of crude acyl chloride 10 which was used in the next step without further purification. A solution of acyl chloride in methylene chloride (20 mL) was added dropwise into a solution of aminopropyl terminated poly(dimethylsiloxane) 5b (5.63 g, 2.25 mmol) and triethylamine (1.43 g, 14.2 mmol) in 100 mL of anhydrous methylene chloride. Evaporation of the solvent under reduced pressure gave 7.73 g of the yellow oil, which was purified by elution through a silica gel column using hexane/methylene chloride (50-100% v/v gradient elution). Removal of the solvent under reduced pressure afforded 5.27 g (73%) of PDMS macro RAFT agent 13b as a yellow semi-solid material. ¹H NMR (400 MHz, CDCl₃) δ 6.55 (t, 2H, ³J=5.6 Hz, C(O)NH), 3.28 (q, 4H, ³J=7.6 Hz, C(S)SCH₂), 3.20 (q, 4H, ³J=7.6 Hz, CONHCH₂), 1.70 (s, 12H, C(S)SC(CH₃)₂), 1.69-1.61 (m, 4H, C(O)NHCH₂CH₂), 1.44-1.18 (m, 20H, CH₃(CH₂)₁₀), 0.89 (t, 6H, ³J=6.8 Hz, CH₃(CH₂)₁₀), 0.49 (dt, 4H, ³J₁=8.8 Hz, ³J₂=4.0 Hz, (CH₃)₂SiOSiCH₂), 0.08 (s, 6H, (CH₃)₂Si). ¹³C NMR (200 MHz, CDCl₃) δ 172.3 (s, C(O)NH), 57.3 (t, C(O)NHCH₂), 55.6 (s, C(S)SC(CH₃)₂), 37.1 (t, C(S)SCH₂), 31.9 (t, C(S)SCH₂CH₂), 29.6 (t, CH₃(CH₂)₉, 2C), 29.5 (t, CH₃(CH₂)₉), 29.4 (t, CH₃(CH₂)₉), 29.3 (t, CH₃(CH₂)₉), 29.1 (t, CH₃(CH₂)₉), 29.0 (t, CH₃(CH₂)₉), 28.9 (t, CH₃(CH₂)₉), 25.3 (q, C(S)SC(CH₃)₂), 23.2 (t, CH₃(CH₂)₉), 22.7 (t, C(O)OCH₂CH₂), 15.4 (q, CH₃(CH₂)₁₀), 14.1 (t, (CH₃)₂SiOSiCH₂), 1.0 (q, (CH₃)₂Si). M_{n,GPC}=5,800 g/mol, M_{n,NMR}=6,830 g/mol, PD=1.55.

### Example 7

### Polymerization of N,N-dimethylacrylamide (DMA) in the Presence of Ester-Based Difunctional Macro RAFT Agent (14b)

A mixture of the PDMS-RAFT macroinitiator 11b (739.0 mg, 0.156 mmol), DMA (1.24 g, 12.5 mmol), and AIBN (5.12 mg, 0.031 mmol) was dissolved in THF (3 mL) and degassed by performing the three freeze-pump-thaw cycles. The reaction mixture was then heated at reflux for 16 h (conversion of DMA was ca. 90% as determined by ¹H NMR). After this time, the viscous reaction mixture was dissolved in THF (4 mL) and precipitated into hexane (500 mL) to give the triblock copolymer 14b, as a bright yellow solid. Yield: 1.63 g. According to NMR integration of the PDMS methyl signals the content of PDMS block in the copolymer was determined to be ca. 43%. ¹H NMR (400 MHz, CDCl₃) δ 4.03-3.86 (m, 4H, C(O)OCH₂), 3.40-3.29 (m, 4H, C(S)SCH₂), 3.25-2.79 (m, 6H, (CH₃)₂N), 2.76-2.15 (m, 1H, CHC(O)N(CH₃)₂, polymer backbone methine protons), 1.95-1.47 (m, 2H, CH₂CHC(O)N(CH₃)₂, polymer backbone methylene protons), 1.46-1.00 (m, 2H, CH₂CHC(O)N(CH₃)₂, polymer backbone methylene protons), 1.26 (s, 18H, CH₃(CH₂)₉), 0.88 (t, 6H, ³J=6.8 Hz, CH₃(CH₂)₁₀), 0.60-0.44 (m, 4H, (CH₃)₂SiOSiCH₂), 0.07 (s, 6H, (CH₃)₂Si). ¹³C NMR (200 MHz, CDCl₃) δ 174.7 (s, C(O)O), 174.5 (s, C(O)O), 37.1, 36.2, 35.8, 34.6, 34.5 (polymer backbone carbons), 31.8 (t, C(S)SCH₂CH₂), 29.6 (t, CH₃(CH₂)₉, 2C), 29.5 (t, CH₃(CH₂)₉), 29.4 (t, CH₃(CH₂)₉), 29.3 (t, CH₃(CH₂)₉), 29.0 (t, CH₃(CH₂)₉), 28.8 (t, CH₃(CH₂)₉), 27.8 (t, CH₃(CH₂)₉), 25.2 (q, C(S)SC(CH₃)₂), 22.6 (t, CH₃(CH₂)₉), 22.5 (t, C(O)OCH₂CH₂), 14.1 (q, CH₃(CH₂)₁₀), 13.9 (t, (CH₃)₂SiOSiCH₂), 1.0 (q, (CH₃)₂Si). M_{n,GPC}=9,950 g/mol, M_{n,NMR}=10,720, PD=1.30.

### Example 8

### Polymerization of N,N-dimethylacrylamide (DMA) in the Presence of Difunctional Amide-Based Macro RAFT Agent (15b)

The macro RAFT agent 13b (976.0 mg, 0.17 mmol) was placed in a 50 mL Schlenk tube, followed by the addition of THF (3 mL), AIBN (5.5 mg, 0.033 mmol), and DMA (1.32 g, 13.3 mmol). The system was purged with nitrogen for 30 min, and placed in an oil bath at 60° C. for 22 h. The reaction mixture was cooled to room temperature, and the viscous oil was diluted with THF (3 mL). The polymer was isolated by precipitation into large amount of hexane (500 mL) to yield 1.04 g of purified triblock copolymer, 15b, as a yellow solid. ¹H NMR (400 MHz, CDCl₃) δ 5.29-5.12 (m, 2H, C(O)NH), 4.92-4.70 (m, 4H, CONHCH₂), 3.41-3.25 (m, 4H, C(S)SCH₂), 3.22-2.78 (m, 6H, (CH₃)₂N), 2.76-2.22 (m, 1H, CHC(O)N(CH₃)₂, polymer backbone methine protons), 1.98-1.46 (m, 2H, CH₂CHC(O)N(CH₃)₂, polymer backbone methylene protons), 1.44-0.97 (m, 2H, CH₂CHC(O)N(CH₃)₂, polymer backbone methylene protons), 0.86 (t, ³J=6.7 Hz, CH₃(CH₂)₁₀), 0.59-0.42 (m, 4H, (CH₃)₂SiOSiCH₂), 0.06 (s, 6H, (CH₃)₂Si). ¹³C NMR (200 MHz, CDCl₃) δ 174.8 (s, C(O)NH), 37.1, 36.2, 35.8 (polymer backbone carbons) 31.9 (t, C(S)SCH₂CH₂), 29.6 (t, CH₃(CH₂)₉, 2C), 29.5 (t, CH₃(CH₂)₉), 29.4 (t, CH₃(CH₂)₉), 29.3 (t, CH₃(CH₂)₉), 29.1 (t, CH₃(CH₂)₉), 22.6 (t, C(O)OCH₂CH₂), 14.1 (t, (CH₃)₂SiOSiCH₂), 1.0 (q, (CH₃)₂Si). M_{n,GPC}=8,780 g/mol, M_{n,NMR}=9,100 g/mol, PD=1.24.

### Example 9

### Synthesis of Difunctional Ester-Based Fomblin Macro RAFT Agent

Oxalyl chloride (6.8 mL) was added to dodecyltrithiocarbonate RAFT agent 9 (2.85 g, 7.8 mmol) at room temperature with rapid stirring, and under a nitrogen atmosphere. After 3 h stirring the evolution of gases had ceased and the reaction was homogenous. The excess oxalyl chloride was removed under reduced pressure to yield reddish oily acyl chloride (3.06 g) which was dissolved in 40 mL of anhydrous methylene chloride. This solution was gradually added dropwise over 2.5 hours period into a solution of Fomblin diol (Fomblin Z DOL 200, 7.22 g, 3.61 mmoL, Solvay) in 130 mL 30% THF/methylene chloride solvent mixture (30 mL THF/100 mL methylene chloride) under nitrogen atmosphere at 0° C. The reaction mixture was stirred for additional 15 h at room temperature. The solvents were removed under reduced pressure to give 10.2 g of orange oil. The resulting oil was dissolved in dichloromethane (100 mL), and subsequently washed with saturated sodium hydrogen carbonate solution (2×100 mL). Organic layer was dried over magnesium sulfate anhydrous, filtered, and the solvents were removed to give 9.25 g of orange oil (95% pure by 1H NMR spectroscopy) which gradually turned into semi-solid crystalline material during overnight standing at room temperature. The product was used without further purification for the preparation of larger amount of triblock copolymer with low, medium and high content of PDMA relative to the Fomblin.

### Example 10

### RAFT Polymerization of DMA using Difunctional Fomblin RAFT Agent

Schlenk flask was charged with Fomblin RAFT agent (1.59 g, 0.60 mmoL), DMA (2.37 g, 23.9 mmoL), AIBN (19.6 mg, 0.119 mmoL) and anhydrous THF (5 mL), and the resulting solution was heated under reflux (60° C.) in an oil bath under nitrogen atmosphere. After 22 h of reflux the solution was allowed to reach ambient temperature and precipitated into 500 mL of hexane to afford 3.37 g of bright yellow solid. Mn,NMR=6,430, Mn,theor=6,460. Fomblin content in triblock=39% by 1H NMR.

### Example 11

### RAFT Polymerization of DMA Using Difunctional Fomblin RAFT Agent

Schlenk flask was charged with Fomblin RAFT agent from example 9 (1.09 g, 0.41 mmoL), DMA (811.0 mg, 8.2 mmoL), AIBN (13.4 mg, 0.08 mmoL) and anhydrous THF (5 mL), and the resulting solution was heated under reflux (60° C.) in an oil bath under nitrogen atmosphere. After 23 h of reflux the solution was allowed to reach ambient temperature and precipitated into 500 mL of hexane to afford 2.0 g of viscous yellow oil. This material was precipitated into diethylether to get 1.11 g of bright yellow oil. Mn,NMR=4,250, Mn,theor=4,480. Fomblin content in triblock=59% by 1H NMR.

### Example 12

### Synthesis of Xanthate-Fomblin-Xantate RAFT Agent

Hydroxymethyl-terminated Fomblin (9.4 g, 4.7 mmoL) was dissolved in anhydrous tetrahydrofuran (75 mL). Triethylamine (2.62 mL, 18.8 mmoL) was added to the stirred solution followed by dropwise addition of bromo-i-propionylbromide (1.49 mL, 14.1 mmoL) dissolved in 35 mL of anhydrous THF. The solution was left overnight at room temperature. The resulting solution was filtered and solvent removed under reduced pressure. The resulting yellow oil obtained was dissolved in methylene chloride (200 mL), and subsequently washed with saturated sodium hydrogencarbonate solution (2×100 mL). Organic layer was dried over anhydrous magnesium sulfate, filtered, and the solvent was removed under reduced pressure to give the desired product as colorless oil. Yield: 8.46 g. This colorless oil (Fomblin diisopropylbromide) (6.02 g, 2.65 mmoL) was dissolved in absolute ethanol (114 mL). Potassium xanthate (1.83 g, 11.41 mmoL) was added to a stirred solution, and the solution was kept stirring at room temperature overnight. Reaction mixture was quenched by adding water (100 mL) followed by extraction with hexane (2×100 mL), and diethyl ether/hexane solution (3:7, 200 mL). After evaporation of solvent the residue was filtered through short plug of silica-gel using hexane as an eluent to give 4.13 g of dixanthate as colorless oil. Dixanthate was analyzed by GPC analysis and NMR spectroscopy.

### Example 13

### RAFT Polymerization of NVP using Difunctional Fomblin RAFT Agent

A Schlenk flask was charged with Fomblin dixanthate of example 12 (827.0 mg, 0.37 mmoL), 1-vinyl-2-pyrrolidone (4.10 g, 36.9 mmoL), AIBN (12.1 mg, 0.074 mmoL) and anhydrous THF (7 mL), and the resulting solution was heated under reflux (65° C.) in an oil bath under nitrogen atmosphere. After 21 h reflux the solution was allowed to reach ambient temperature. Reaction mixture was dissolved in 20 mL THF and precipitated into diethyl ether (600 mL) to give triblock copolymer as a white solid (Yield=4.23 g). Product was characterized by 1H NMR and GPC analysis.

### Example 14

### Lenses containing Amphiphilic Multiblock Copolymers and Coefficient of Friction Determination

The lenses evaluated in this study were Balafilcon A lenses with two different types of PVP-PDMS-PVP triblock copolymer added to the formulation. The PVP-PDMS-PVP triblocks differed in the amount of PVP that was polymerized from the end of the PDMS dixanthate. Sample DP-02-040 had a composition by 1H NMR of 59% by weight PDMS and 41% by weight of PVP. Sample DP-02-047 had a composition by 1H NMR of 19% by weight PDMS and 81% by weight of PVP. The 1H NMR of DP-02-047 is shown in FIG. 4. Balafilcon A is disclosed in U.S. Pat. No. 5,260,000. Table 1 shows the copolymer used in each series along with the extraction solvent used to process the lens. All lenses were evaluated relative to commercially obtained Acuvue Oasys® lenses (COF value=1).

TABLE 1
Balafilcon A lenses Made in Poly(propylene) Molds.

| Series | | Triblock | Extraction |
|---|---|---|---|
| Number | Lot # | polymer | Solvent |
| 7 | 2748-145-3 | None | Water |
| 8 | 2748-145-3 | None | 30% IPA |
| 9 | 2748-145-3 | None | 100% IPA |
| 10 | 2748-145-2 | PVP tri-block | Water |
| | | (DP-02-047) | |
| 11 | 2748-145-2 | PVP tri-block | 30% IPA |
| | | (DP-02-047 | |
| 12 | 2748-145-2 | PVP tri-block | 100% IPA |
| | | (DP-02-047 | |
| 13 | 2748-145-1 | PVP tri-block | Water |
| | | (DP-02-040) | |
| 14 | 2748-145-1 | PVP tri-block | 30% IPA |
| | | (DP-02-040) | |
| 15 | 2748-145-1 | PVP tri-block | 100% IPA |
| | | (DP-02-040) | |

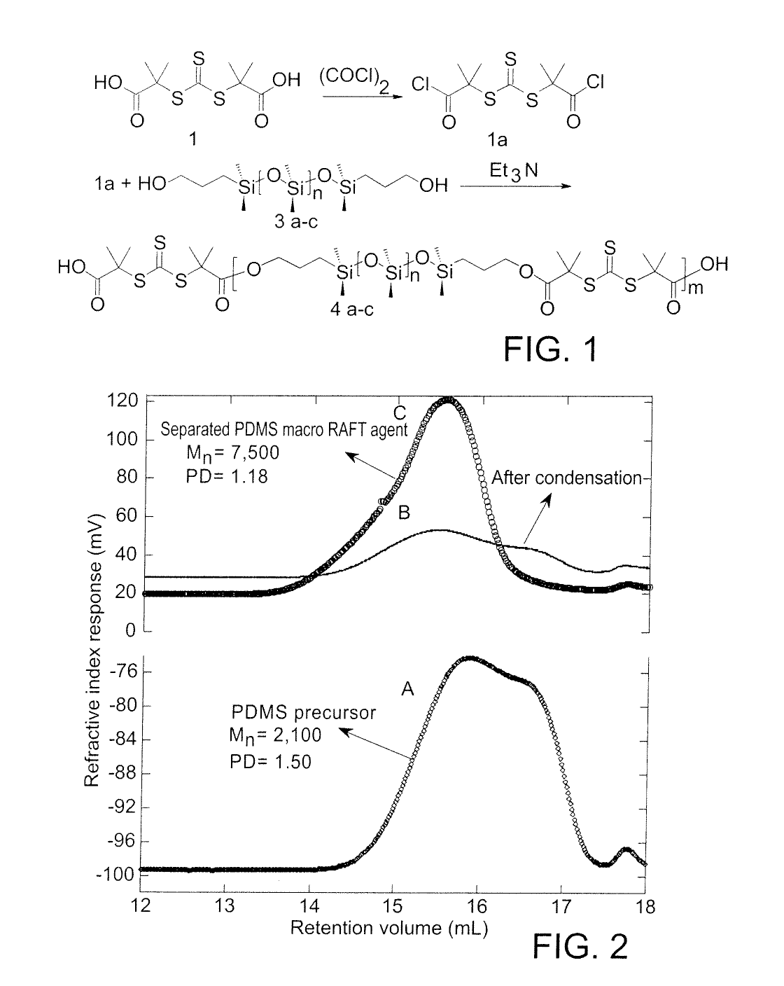

Tribological testing was performed on a CETR Model UMT-2 micro-tribometer. Each lens was clamped on an HDPE holder that initially mates with the posterior side of the lens. A poly(propylene) clamping ring was then used to hold the edge region of the lens. Once the lens was mounted in the holder the assembly was placed in a stationary clamping device within the micro-tribometer. A polished stainless steel disc containing 1 mL of phosphate buffered saline (PBS) was then brought into contact with the lens and F_{N} was adjusted to 2 grams over the course of the run for the frictional measurements. After the load equilibrated for 5 seconds the stainless steel disc was rotated at a velocity of 12 cm/sec for a duration of 20 sec in both the forward and reverse directions and the peak (static) and average (kinetic) COF values (as indicated in FIG. 1) were recorded. Each value represents the average of 6 lenses. All data was normalized to the average values obtained at 2 g force from the lens holder in the absence of a lens tested in PBS. PBS was used as the test-in solution for every lens. All lenses measured were made using poly(propylene) molds

### Results and Conclusions

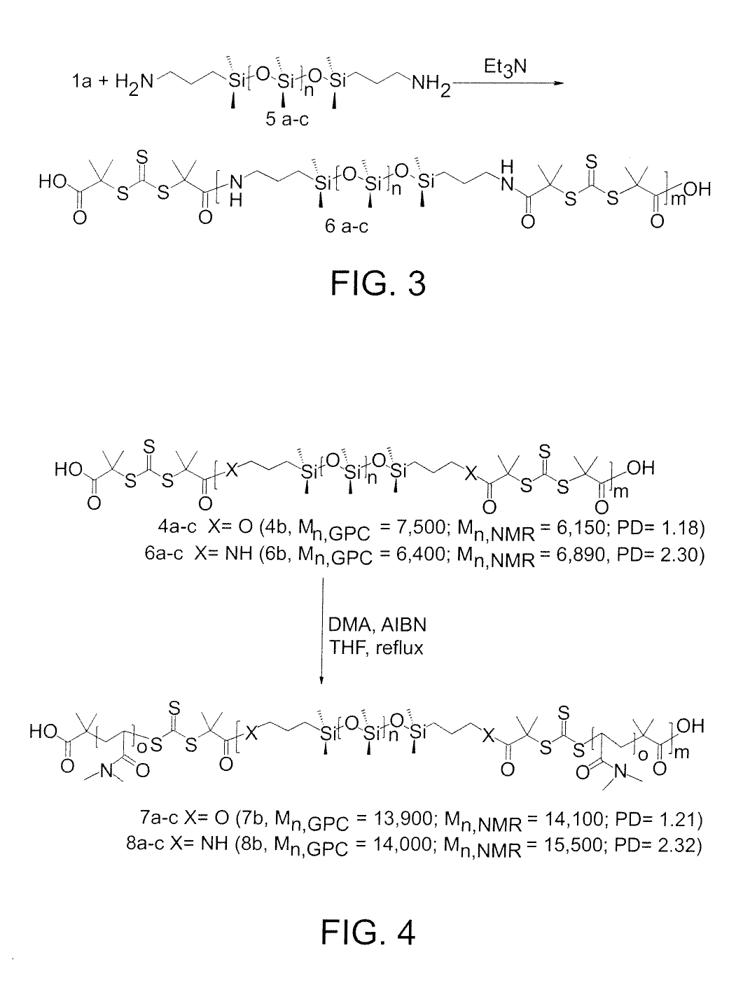

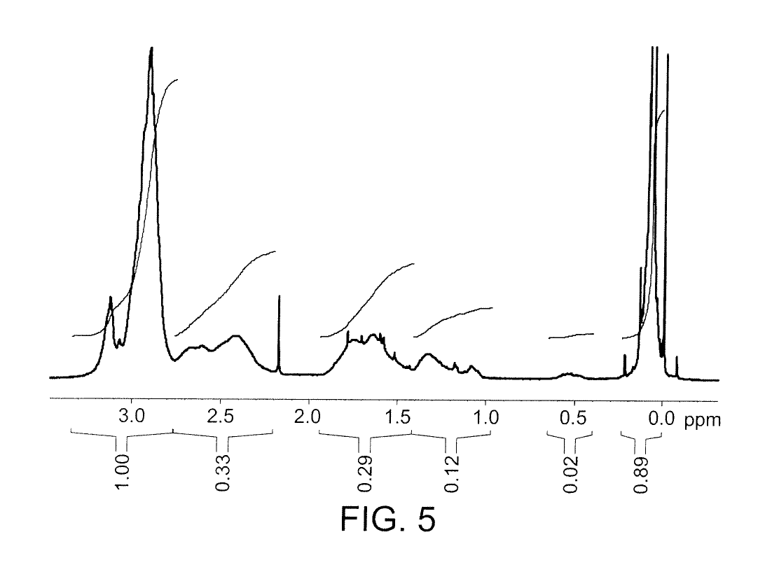

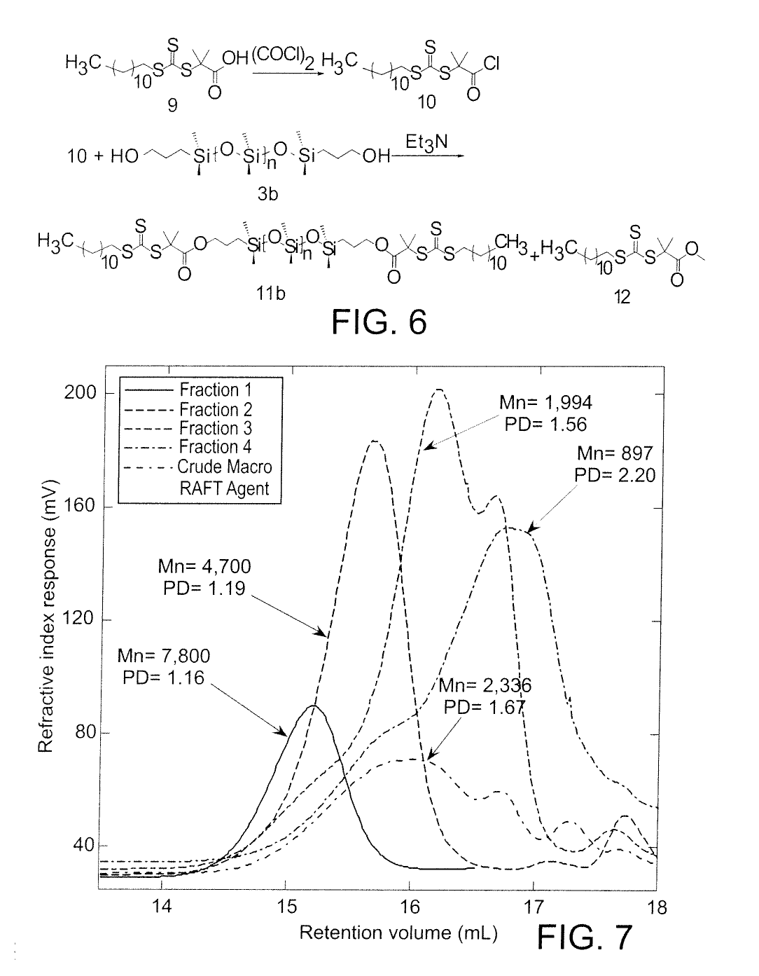

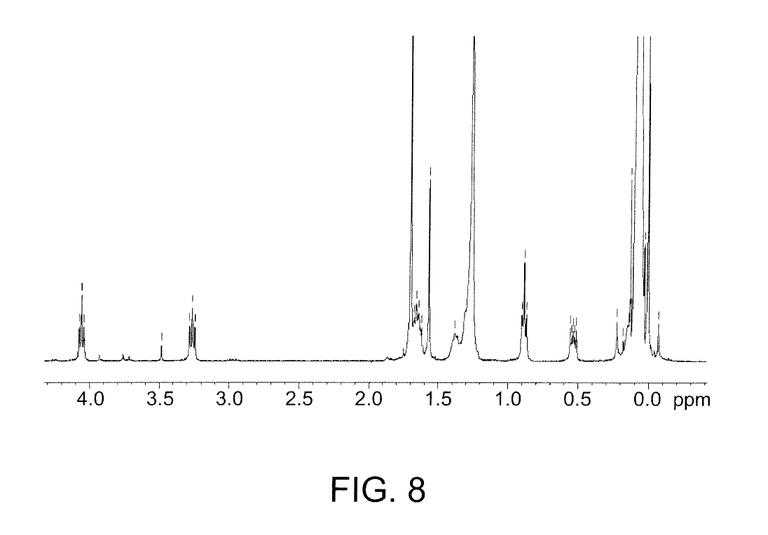

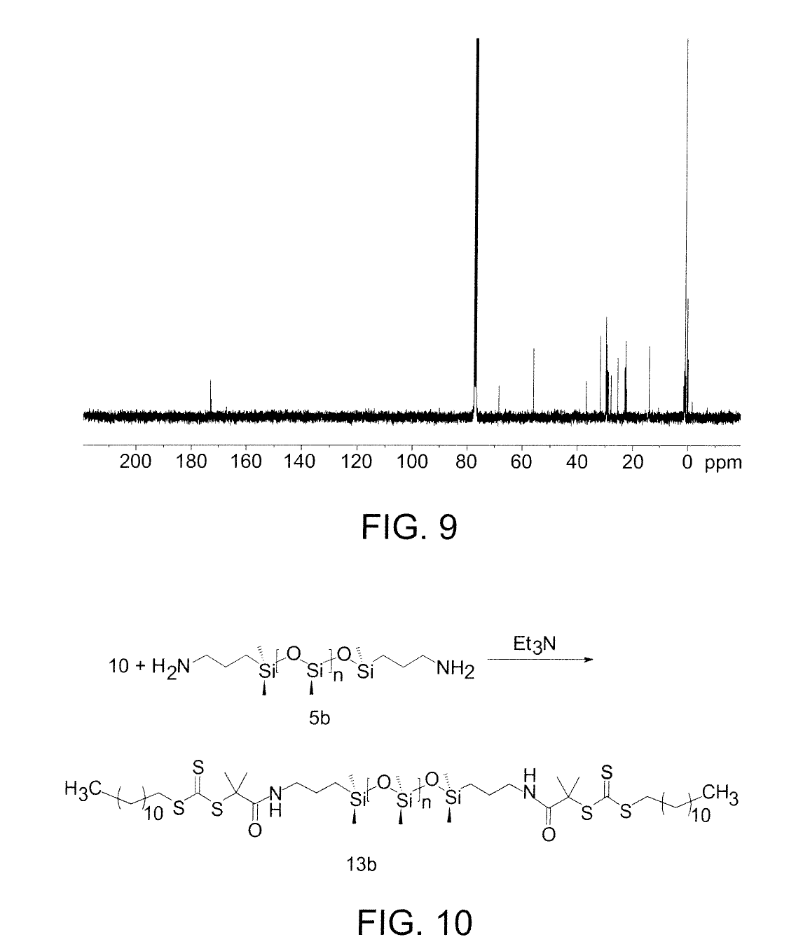

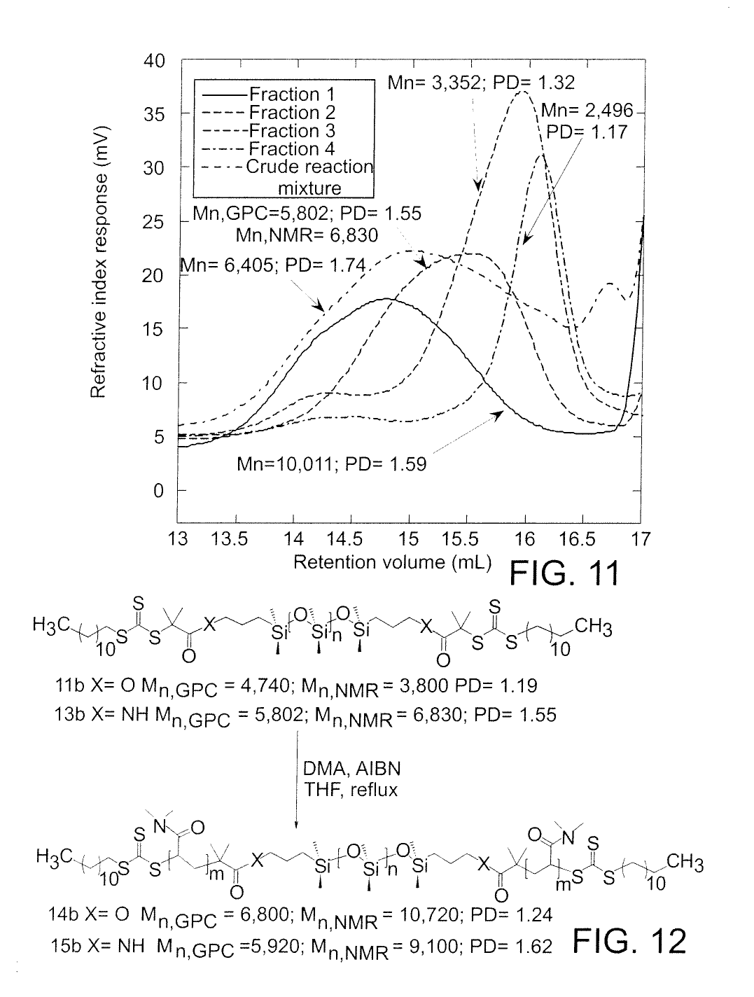

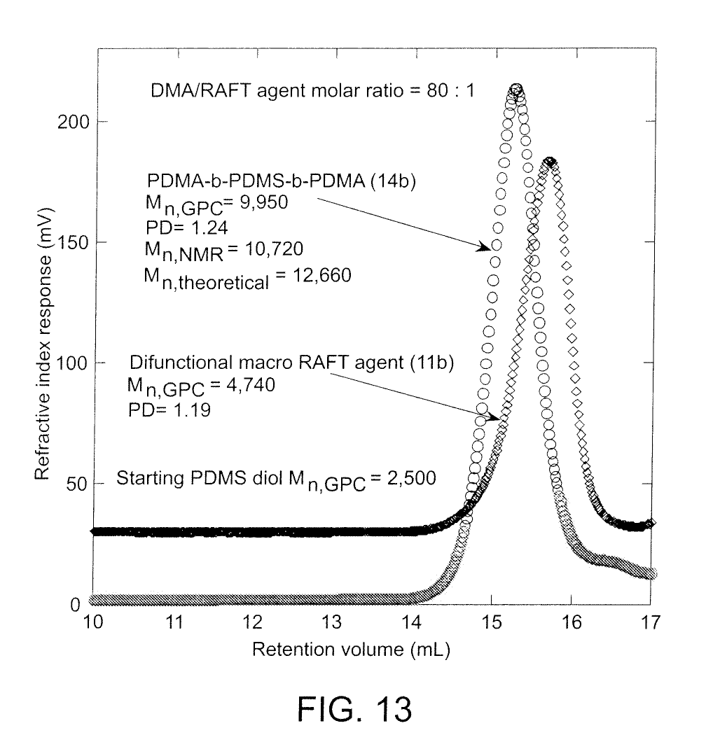

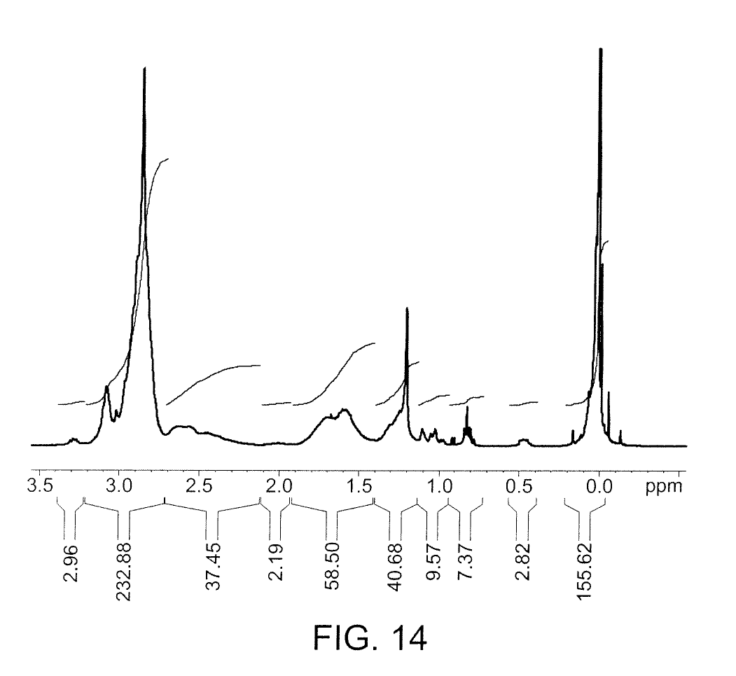

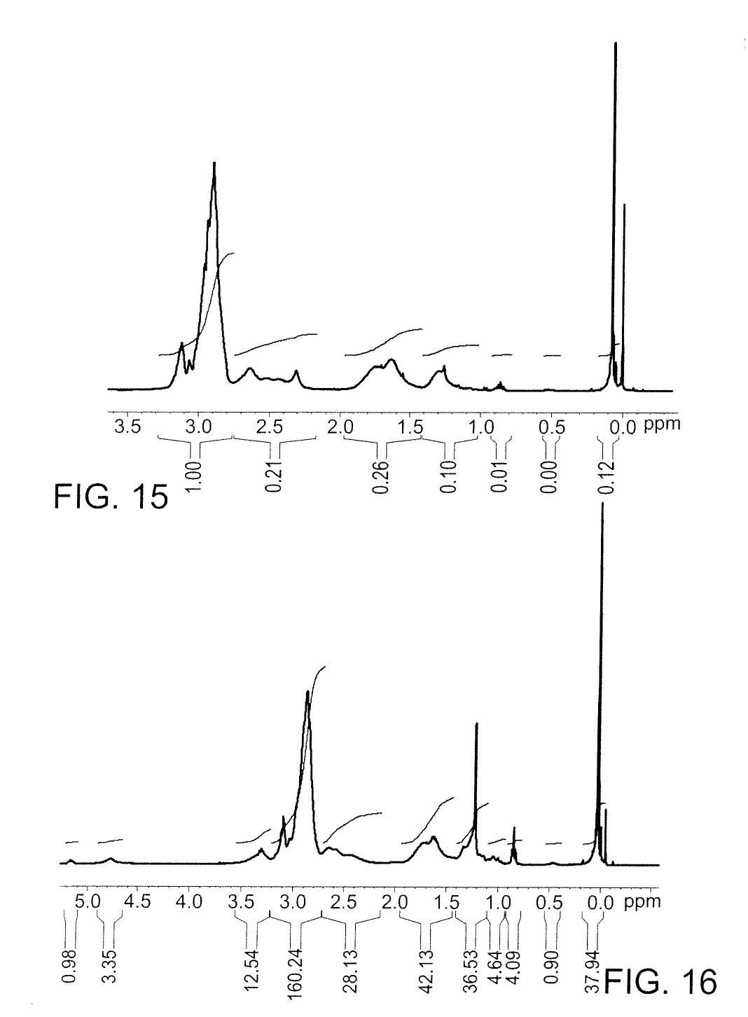

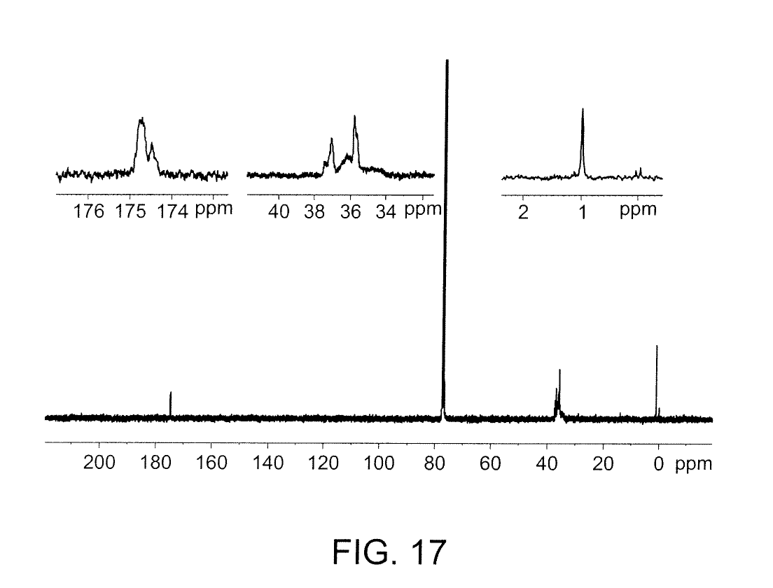

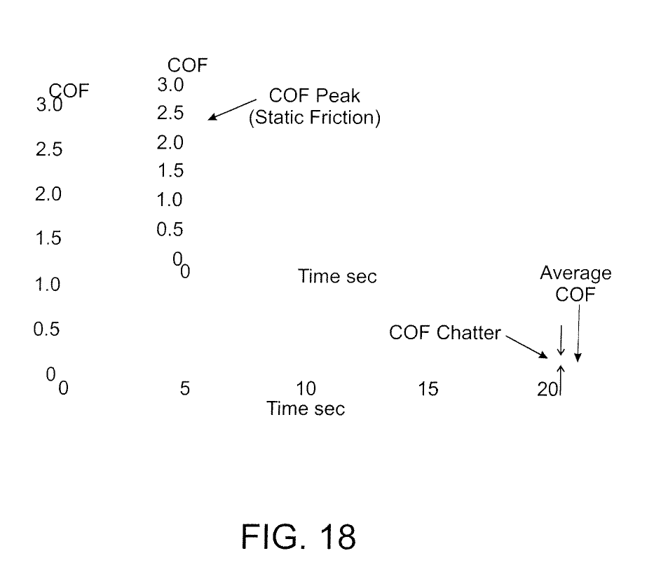

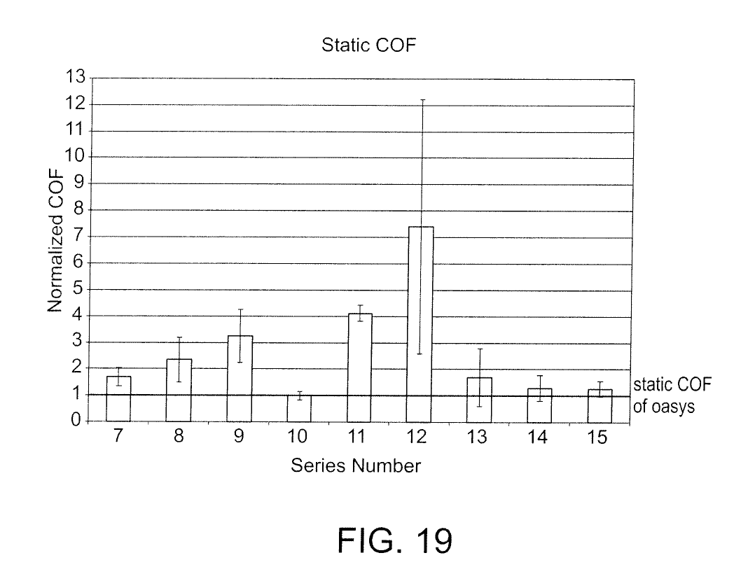

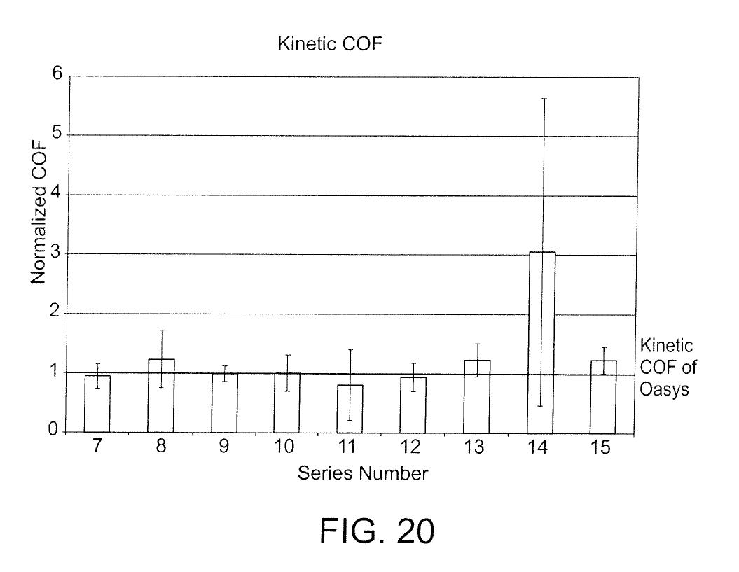

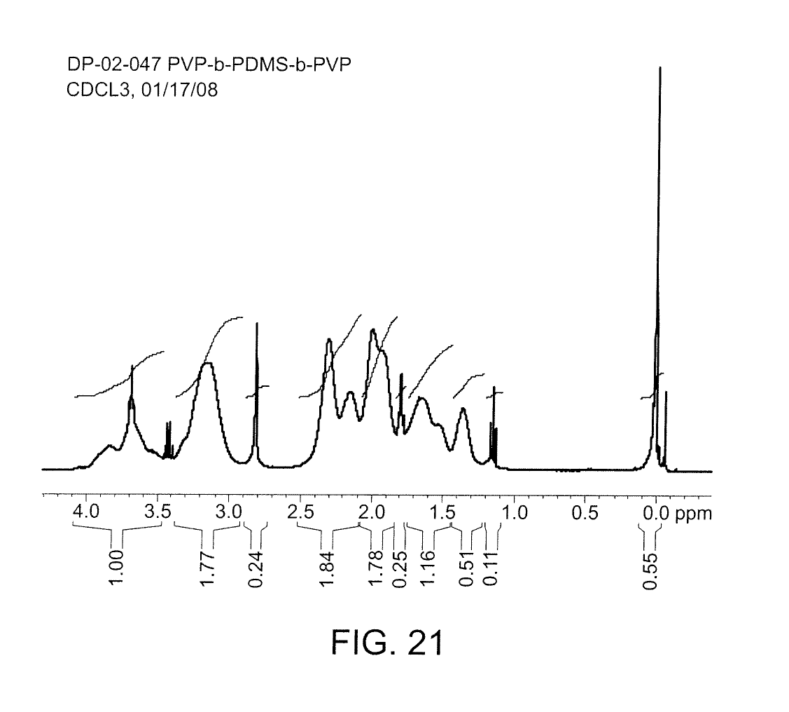

Results for the normalized static and kinetic COF values are presented graphically in FIGS. 2 and 3, respectively.

Results for static COF showed that lenses made with the DP-02-047 copolymer had the most significant change in COF as the level of IPA increased. DP-02-047 lenses had the lowest static COF when extracted in water, as the level of IPA increased the static COF increased. The DP-02-047 lens extracted in water also had the static value closest to Acuvue Oasys. The control lenses also showed this trend of increasing static COF with increasing levels of IPA. Lenses made with DP-02-040 did not follow this trend; all lenses had very similar and low static COF values. The error bars were quite large for some of the data, this could be due to the fact that the lenses were small and were difficult to mount onto the plastic ball

The kinetic COF values for the lenses are similar and do not show a trend of increased kinetic COF friction due to increased levels of WA as the extraction solvent. In this series, the triblock lens DP-02-040 extracted in 30% IPA had the highest kinetic COF value and the triblock lens DP-02-047 extracted in 30% IPA had the lowest kinetic COF. All other lenses had kinetic COF values comparable to Acuvue Oasys.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An ophthalmic device comprising:
a polymerized comonomer mixture comprising an amphiphilic multiblock copolymer comprising a hydrophobic segment and a hydrophilic segment, wherein the amphiphilic multiblock copolymer has at least one thio carbonyl thio group capable of participating in a free radical reaction.

2. The ophthalmic device of claim 1 wherein the ophthalmic device is a contact lens.

3. The ophthalmic device of claim 2 wherein the contact lens is a rigid gas permeable contact lens.

4. The ophthalmic device of claim 2 wherein the lens is a soft contact lens.

5. The ophthalmic device of claim 2 wherein the lens is a hydrogel contact lens.

6. The ophthalmic device of claim 1 wherein the lens is an intraocular lens.

7. The ophthalmic device of claim 6 wherein the lens is a phakic intraocular lens.

8. The ophthalmic device of claim 6 wherein the lens is an aphakic intraocular lens.

9. The ophthalmic device of claim 1 wherein the device is a corneal implant.

10. The device of claim 1 wherein the hydrophobic segment is selected from the group consisting of polysiloxanes, perfluorinated polyethers and polydienes.

11. The device of claim 1 wherein the hydrophilic segment is formed of polymerized monomers selected from the group consisting of 2-hydroxyethyl methacrylate, glycerol methacrylate, methacrylic acid, acrylic acid, methacrylamide, acrylamide, N,N′-dimethylmethacrylamide, N,N′-dimethylacrylamide; ethylenically unsaturated poly(alkylene oxide)s, cyclic lactams, N-vinyl-2-pyrrolidone, hydrophilic vinyl carbonate, hydrophilic vinyl carbamate monomers, 2-hydroxyethyl acrylate, 2-(2-ethoxyethoxy)ethyl (meth)acrylate, glyceryl(meth)acrylate, poly(ethylene glycol (meth)acrylate), tetrahydrofurfuryl(meth)acrylate, N-vinyl acetamide, copolymers, derivatives and combinations thereof.

12. The device of claim 1 wherein the thiocarbonylthio group capable of participating in a free radical reaction is selected from the group consisting of dithioesters, trithiocarbonates, dithiocarbamates and xanthates.

13. The ophthalmic device of claim 1 further comprising as part of the comonomer mixture an organo silicon compound.

14. The ophthalmic device of claim 13 wherein the silicon compound is selected from the group consisting of siloxanyl(meth)acrylate, siloxanyl(meth)acrylamide, siloxynyl vinyl carbamate, polymerizable siloxane oligomers and macromonomers and mixtures thereof.

15. The ophthalmic device of claim 13 further comprising as part of the monomer mixture at least one member selected from the group consisting of crosslinking agents, internal wetting agents, hydrophilic monomers and toughening agents.

16. The ophthalmic device of claim 15 wherein the hydrophilic monomers are selected from the group consisting of hydrophilic acrylic-, methacrylic-, itaconic-, styrenyl-, acrylamido-, methacrylamido- and vinyl-containing monomers and mixtures thereof.

17. The ophthalmic device of claim 16 wherein the hydrophilic monomers are selected from the group consisting of monomers containing the acrylic group represented by the formula: 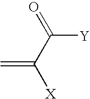
wherein X is hydrogen or methyl and Y is —O—, —OQ-, —NH—, —NQ- and —NH(Q)-, and Q is an alkyl or substituted alkyl group; and mixtures thereof.

18. The ophthalmic device of claim 16 wherein the vinyl-containing hydrophilic monomers are selected from the group consisting of N-vinyllactams, N-vinylpyrrolidone, N-vinyl-N-methylacetamide, N-vinyl-N-ethylacetamide, N-vinyl-N-ethylformamide, N-vinylformamide, and mixtures thereof.

19. The ophthalmic device of claim 16 wherein the hydrophilic monomers are selected from the group consisting of as N,N-dimethylacrylamide, 2-hydroxyethyl methacrylate, glycerol methacrylate, 2-hydroxyethyl methacrylamide, methacrylic acid, acrylic acid and mixtures thereof.

20. The ophthalmic device of claim 1 further comprising as part of the comonomer mixture an ethylenically unsaturated hydrophilic monomer selected from the group consisting of ethylenically unsaturated polyoxyalkylenes, ethylenically unsaturated polyacrylamides, ethylenically unsaturated polyvinylpyrrolidones, ethylenically unsaturated polyvinyl alcohols, ethylenically unsaturated poly(hydroxyethyl methacrylate), ethylenically unsaturated N-alkyl-N-vinyl acetamides and mixtures thereof.

21. The ophthalmic device of claim 20 wherein the ethylenic unsaturation is provided by a group selected from (meth)acrylate, (meth)acrylamide, styrenyl, alkenyl, vinyl carbonate, vinyl carbamate groups and mixtures thereof.

22. The ophthalmic device of claim 1 further comprising hydrophobic monomers.

23. The ophthalmic device of claim 22 wherein the hydrophobic monomer is selected from the group consisting of alkyl(meth)acrylates, N-alkyl(meth)acrylamides, alkyl vinylcarbonates, alkyl vinylcarbamates, fluoroalkyl(meth)acrylates, N-fluoroalkyl (meth)acrylamides, N-fluoroalkyl vinylcarbonates, N-fluoroalkyl vinylcarbamates, silicone-containing (meth)acrylates, (meth)acrylamides, vinyl carbonates, vinyl carbamates, styrenic monomers such as styrene, alpha-methyl styrene, ρ-methyl styrene, ρ-t-butyl monochloro styrene, and ρ-t-butyl dichloro styrene; polyoxypropylene (meth)acrylates, methyl methacrylate, dodecyl methacrylate, octafluoropentyl methacrylate, perfluorooctyl methacrylate, methacryoyl oxypropyl tris(trimethylsiloxy)silane (TRIS) and mixtures thereof.

24. The ophthalmic device of claim 1 further comprising a free radical thermal polymerization initiators selected from the group consisting of organic peroxides such as acetyl peroxide, lauroyl peroxide, decanoyl peroxide, stearoyl peroxide, benzoyl peroxide, t butyl peroxypivalate, peroxydicarbonate and mixtures thereof.

25. The ophthalmic device of claim 1 further comprising a UV initiator.

26. A method of forming an ophthalmic device comprising:
providing a polymerizable mixture comprising an amphiphilic multiblock copolymer comprising a hydrophobic segment and a hydrophilic segment, wherein the amphiphilic multiblock copolymer has at least one thio carbonyl thio group capable of participating in a free radical reaction;
subjecting the polymerizable mixture to polymerizing conditions; and,
shaping the polymerizable mixture into the desired shape of the ophthalmic device.

27. The method of claim 26 wherein the hydrophobic segment is selected from the group consisting of polysiloxanes, perfluorinated polyethers and polydienes.

28. The method of claim 26 wherein the hydrophilic segment is formed of polymerized monomers selected from the group consisting of 2-hydroxyethyl methacrylate, glycerol methacrylate, methacrylic acid, acrylic acid, methacrylamide, acrylamide, N,N′-dimethylmethacrylamide, N,N′-dimethylacrylamide; ethylenically unsaturated poly(alkylene oxide)s, cyclic lactams, N-vinyl-2-pyrrolidone, hydrophilic vinyl carbonate, hydrophilic vinyl carbamate monomers, 2-hydroxyethyl acrylate, 2-(2-ethoxyethoxy)ethyl (meth)acrylate, glyceryl(meth)acrylate, poly(ethylene glycol (meth)acrylate), tetrahydrofurfuryl(meth)acrylate, N-vinyl acetamide, copolymers, derivatives and combinations thereof.

29. The method of claim 26 wherein the thiocarbonylthio group capable of participating in a free radical reaction is selected from the group consisting of dithioesters, trithiocarbonates, dithiocarbamates and xanthates.

30. The method of claim 26 wherein the step of shaping occurs after subjecting the polymerizable mixture to polymerization conditions.

31. The method of claim 26 wherein the step of shaping comprises cutting, lathing, polishing and combinations thereof.

32. The method of claim 26 further comprising the step of placing the polymerizable mixture comprising a comonomer mixture comprising at least one polymerizable surfactant selected from the group consisting of poloxamers having at least one end terminal functionalized, reverse poloxamers having at least one end terminal functionalized, poloxamines having at least one end terminal functionalized, reverse poloxamines having at least one end terminal functionalized and mixtures thereof in a mold prior to the step of subjecting the polymerizable mixture to polymerization conditions.

33. The method of claim 32 wherein the step of polymerizing is conducted in a mold selected from the group consisting of spinning molds and stationary molds.

34. The method of claim 26 wherein the step of polymerizing is conducted in an appropriate mold or vessel to form buttons, plates or rods.

35. The method of claim 26 further comprising the step of hydrating the polymerized mixture.

36. The method of claim 26 wherein the ophthalmic device formed is selected from the group consisting of rigid gas permeable contact lens, soft contact lens, intraocular lens, phakic intraocular lens, aphakic intraocular lens and corneal implant.

37. An amphiphilic multiblock copolymer comprising a hydrophobic segment and a hydrophilic segment, wherein the amphiphilic multiblock copolymer has at least one thio carbonyl thio group capable of participating in a free radical reaction.

38. The amphiphilic multiblock copolymer of claim 37 wherein the hydrophobic segment is selected from the group consisting of polysiloxanes, Perfluorinated polyethers and polydienes.

39. The amphiphilic multiblock copolymer of claim 37 wherein the hydrophilic segment is formed of polymerized monomers selected from the group consisting of 2-hydroxyethyl methacrylate, glycerol methacrylate, methacrylic acid, acrylic acid, methacrylamide, acrylamide, N,N′-dimethylmethacrylamide, N,N′-dimethylacrylamide; ethylenically unsaturated poly(alkylene oxide)s, cyclic lactams, N-vinyl-2-pyrrolidone, hydrophilic vinyl carbonate, hydrophilic vinyl carbamate monomers, 2-hydroxyethyl acrylate, 2-(2-ethoxyethoxy)ethyl(meth)acrylate, glyceryl(meth)acrylate, poly(ethylene glycol (meth)acrylate), tetrahydrofurfuryl(meth)acrylate, N-vinyl acetamide, copolymers, derivatives and combinations thereof.

40. The amphiphilic multiblock copolymer of claim 37 wherein the thiocarbonylthio group capable of participating in a free radical reaction is selected from the group consisting of dithioesters, trithiocarbonates, dithiocarbamates and xanthates.
